(19) United States
(12) Patent Application Publication
(10) Pub. No.: US 2016/0236173 A1
(43) Pub. Date: Aug. 18, 2016

(54) POLYMERIZATION SYSTEM HAVING A REGENERATION DEVICE FOR AN ADSORPTIVE AND/OR CATALYTIC CLEANING DEVICE, REGENERATION DEVICE, AND REGENERATION METHOD

(71) Applicant: LINDE AKTIENGESELLSCHAFT, München (DE)

(72) Inventors: Volker Witzleb, Dresden (DE); Markus Dietzen, Dresden (JP); Uwe Göbel, Dresden (DE); Andre Heller, Zittau (DE); Oliver Grosse, Dresden (DE)

(21) Appl. No.: 15/027,003

(22) PCT Filed: Oct. 2, 2014
(86) PCT No.: PCT/EP2014/002690

§ 371 Date: Apr. 4, 2016

(30) Foreign Application Priority Data
Oct. 15, 2013 (DE) 10 2013 017 123.7

(51) Int. Cl. B01J 20/34; B01D 53/04; C08F 10/06; C08F 36/04; B01J 38/12; B01J 38/04

(52) U.S. Cl. CPC B01J 20/3458; B01J 38/12; B01J 38/04; C08F 10/06; C08F 36/04; B01D 53/0423; B01D 2253/104; B01D 2256/24; B01D 2257/108; B01D 2257/104; B01D 2257/304; B01D 2257/306; B01D 2257/308; B01D 2257/406; B01D 2257/502; B01D 2257/504; B01D 2257/80; B01D 2257/55

(57) ABSTRACT

A polymerisation system for obtaining at least one polymerisation product from at least one gaseous, hydrocarbon-rich feed stream, which system has at least one catalytic and/or adsorptive cleaning device for the at least partial extraction of at least one undesirable component in the at least one feed stream and a regeneration device for the regeneration of the cleaning device. The regeneration device is designed to at least intermittently condition and conduct a regeneration gas stream through the cleaning device by means of a partially closed gas circuit. There is further provided a corresponding regeneration method.

The present invention relates to a polymerization plant for obtaining at least one polymerization product using at least one gaseous, hydrocarbon-rich feed stream, and to a regenerating unit and a regeneration method according to the preamble of the independent claims.

### STATE OF THE ART

In the case of obtaining polymerization products from gaseous, hydrocarbon-rich feed streams, they are frequently not used directly for polymerization but purified beforehand. This is described hereinafter using the example of the preparation of ethylene-propylene elastomers, but also applies to a multitude of other plants.

Ethylene-propylene elastomers are described, for example, in the article “Rubber, 3. Synthetic” in Ullmann's Encyclopedia of Industrial Chemistry, online publication, Jun. 15, 2000, DOI 10.1002/14356007.a23_233.pub4. This is a family of random copolymers having a fully saturated polymer backbone, which is the reason why the abbreviation M is used according to DIH/ISO 1629. A distinction is made between ethylene-propylene copolymers (EPM) and terpolymers (EPDM).

The ethylene and propylene monomers used for preparation of EPM and EPDM are typically used with a purity of more than 99% and have to be substantially free of impurities such as hydrogen, oxygen, water, carbon monoxide, carbon dioxide, ammonia, methanol, acetylene, methylacetylene, carbon disulfide, carbonyl sulfide, sulfur, hydrogen arsenide and hydrogen sulfide, and also mercaptans, nitrites, oxygenates and phosphines. The residual contents of such compounds must not exceed particular minimum amounts, since some of them are catalyst poisons for the Ziegler-Natta or metallocene catalysts used, for example, in the polymerization or can impair the polymerization in other ways.

If the ethylene and propylene monomers come from typical sources, for example steamcrackers which are operated with crude gasoline as feed, however, they still contain considerable amounts of corresponding impurities. They are therefore removed by using purifying units in which it is also possible for two or more purification stages to be connected in series. Such purification stages are each vessels containing a catalytic and/or adsorptive purifying medium, optionally on corresponding supports, and through which ethylene and propylene are typically conducted as separate gas streams.

For example, in an ethylene stream, in a first step, hydrogen, oxygen, carbon, monoxide and acetylene can be converted over metal oxide catalysts. In one or more further steps, water, carbon dioxide, ammonia and oxygenates can each be removed by adsorption with suitably modified alumina.

In a first adsorption step over suitably modified alumina, carbon dioxide, carbon disulfide, carbonyl sulfide and hydrogen sulfide can be removed from a propylene stream by adsorption. In a further adsorption step over suitably modified alumina, it is possible to remove water, ammonia, oxygenates, mercaptans and nitrides. Hydrogen arsenide and phosphines can subsequently be converted over metal oxide catalysts. In further adsorption steps over suitably modified alumina, carbon monoxide and carbon dioxide are then removed.

It will be apparent that said steps can also be used in a different sequence and, according to the impurities present, also in a different combination or only in part.

The catalytic and/or adsorptive purifying units mentioned have to be regenerated after their capacity has been exhausted. This is done at least partly by means of a regeneration gas stream which is passed through the vessels mentioned and is free of the components to be removed in each case. The regeneration gas stream is typically suitably conditioned, i.e. heated, cooled, brought to a particular pressure and/or contacted with additional gas streams.

The regeneration gas stream used is especially pure nitrogen, to which further components may optionally be added. However, the provision of correspondingly large amounts of pure nitrogen is inconvenient and costly.

The aim of the invention is to provide a remedy here and to make the regeneration of catalytic and/or adsorptive purifying units in polymerization plants simpler and less expensive.

### DISCLOSURE OF THE INVENTION

Against this background, the invention proposes a polymerization plant for obtaining at least one polymerization product from at least one gaseous, hydrocarbon-rich feed stream, having at least one catalytic and/or adsorptive purifying unit for at least partial removal, of at least one unwanted component in the at least one feed stream and having a regenerating unit for regeneration of the purifying unit, a corresponding regenerating unit, and a corresponding regeneration method having the features of the independent claims. Preferred configurations are the subject of the dependent claims and the description which follows.

Against the background of the advantages achievable in the context of the present invention, some of the terms used are elucidated.

A “polymerization plant” is understood here to mean a plant set up to synthesize a polymer from monomers, especially a plant to which the particular monomers are supplied as gaseous, hydrocarbon-rich streams. More particularly, this may be a polymerization plant for preparation of ethylene-propylene elastomers such as EPM and EPDM, using ethylene and propylene as monomers. These monomers are fed to the polymerization plant in the form of separate gas streams and purified individually. In other polymerization plants, however, it may also be the case that two or more gaseous, hydrocarbon-rich feed streams are combined with one another and purified together.

A “polymerization product” is any product from such a plant which is obtained from corresponding monomers by polymerization. This may especially comprise co- or terpolymers, especially EPM and EPDM.

The “catalytic and/or adsorptive purifying unit” comprises one or more vessels comprising a catalytic and/or adsorptive purifying medium, optionally on appropriate supports. This also includes purifying media for what is called chemisorption. Corresponding vessels are referred to hereinafter as “purifying vessels”. The gaseous, hydrocarbon-rich teed stream(s) is/are conducted through these purifying vessels and purified in the process. A corresponding teed stream can also be conducted successively through a plurality of corresponding purifying vessels; it is likewise possible to purify a feed stream in two or more purifying vessels in parallel. As elucidated above, for purification of ethylene and propylene to prepare ethylene-propylene elastomers, typically two or more purification stages (and hence purification vessels) are arranged in series.

A “regenerating unit” is set up to regenerate the purifying unit by guiding one or more gaseous streams through one or more purifying vessels filled with the adsorptive and/or catalytic purifying medium. A corresponding regenerating unit may be intended for passage of a gas stream, referred to here as “regeneration gas stream”, either just through one purifying vessel or successively or in parallel through two or more purifying vessels of a corresponding purifying unit. If a regenerating unit, in terms of capacity, is set up to simultaneously charge two or more purifying vessels in parallel with a regeneration gas stream, this accelerates the regeneration. Especially in cases where a regeneration is required only rarely, however, it is favorable to set the dimensions of a regenerating unit such that just one purifying vessel in each case or only some of the purifying vessels is/are charged with the regeneration gas stream. This enables smaller and less expensive configuration of the regenerating unit which is only required temporarily in any case.

The “conditioning” of the regeneration gas stream in the present case comprises any adjustment of its chemical and/or physical properties. More particularly, the conditioning encompasses heating, cooling, setting of a given pressure, feeding-in of further components, purification of the regeneration gas stream itself and/or the setting of a given flow rate.

A “partly closed gas circuit/” is a gas circuit in which the predominant proportion of the gas present is conducted in a cycle in regular operation. However, a partly closed gas circuit may also include devices for feeding or withdrawal of gas streams, for example for discharge of unwanted components and/or for conditioning of a regeneration gas scream which is conducted in the gas circuit. However, always at least 75%, and optionally also at least 80%, 30%, 35% or 39%, of the gas present in the gas circuit, for example in a regeneration gas stream, is conserved, such that only a correspondingly small proportion of at most 25%, and optionally also at most 20%, 10%, 5% or 1%, is replaced by withdrawal or feeding of fresh gas. However, it will be apparent that, on startup of a corresponding gas circuit, it can initially be filled with an appropriate gas and if necessary also purged repeatedly with gas.

### Advantages of the Invention

The present invention proceeds from a polymerization plant known per se for obtaining at least one polymerization product from at least one gaseous, hydrocarbon-rich feed stream. Such a polymerization plant has at least one catalytic and/or adsorptive purifying unit for at least partial removal of at least one unwanted component in the at least one feed stream and comprises a regenerating unit for regeneration of the purifying unit. The features of a polymerization plant formed from corresponding components have already been elucidated above.

According to the invention, the regenerating unit is set up for at least temporary conditioning and at least temporary guiding of a regeneration gas stream through the purifying unit by means of a partly closed gas circuit. As elucidated, in such a partly closed gas circuit, in each cyclic pass, always at lease 75% or more of the gas present in the gas circuit, the regeneration gas stream here, is conserved. This is advantageous because this can save considerable amounts of regeneration gas, especially pure nitrogen.

For example, in a polymerization plant for preparation of EPDM, up to 12 tonnes of ethylene per hour and up to 8.6 tonnes of propylene per hour are purified. The regeneration of adsorptive and/or catalytic purifying units used for this purpose requires, in conventional plants, nitrogen costing up to 500 000 euros per year, assuming a typical retail price for pure nitrogen of 120 euros per tonne. Even assuming lower nitrogen prices, for example 60 euros per tonne, the pure nitrogen required is a considerable cost factor. In conventional plants, the nitrogen used here is blown off into the environment after flowing through the purifying unit. To reduce this amount, EP 2 421 902 A1 discloses a process which enables a reduction in the total nitrogen consumption by about 35% and in the maximum volume flow rate by about 16%. However, by the use of the partly closed gas circuit of the present invention, it is possible to achieve another distinct improvement in the reduction.

This gives rise to significant sac lugs in the operating costs of corresponding plants, especially of plants for provision of pure nitrogen or other suitable regeneration gases. Corresponding plants or the retrofitting of existing plants lead only to small additional capital costs because, for example, a corresponding supply system for pure nitrogen can be designed for a lower performance because of the lower total and peat demand.

By means of the method proposed in accordance with the invention, the total nitrogen consumption is reduced by up to 70%. The implementation costs for the provision of the regeneration unit configured in accordance with the invention are typically amortized within less than 2 years.

The polymerization plant of the invention, because of the specific configuration of the regenerating unit, enables a multitude of conditioning options for a corresponding regeneration gas stream. For this purpose, advantageously at least one heating device, at least one cooling unit and/or at least one compressor is/are provided in the gas circuit of the regenerating unit. The regenerating unit can thus make flexible use of different modes of operation in the regeneration, for example for drying, oxidation, reduction and for further steps in the regeneration in the purifying vessels. All steps of this kind are summarized by the umbrella term “regeneration”.

For two or more purifying vessels of a purifying unit, it is possible for a common regenerating unit to be provided and be used as a common regeneration system for different types of adsorptive and/or catalytic purifying media.

In other words, different adsorbers and/or catalytic purifying reactors (which can also work by means of what is called chemisorption) can be charged with the regeneration gas stream. The regeneration gas in the circuit elucidated can be heated, cooled and, for example, diluted with air. It is also possible to continuously feed a limited amount of fresh nitrogen into the circuit. The discharge of a particular amount of the regeneration gas from the at least partly closed gas circuit can be effected under pressure regulation, as a result of which it is especially possible to maintain a given (back)pressure in the gas circuit.

As elucidated, it is thus possible for the gas circuit, for this purpose, to have at least one feed unit and/or at least one withdrawal unit for a gas stream. For particular regeneration tasks, for example, a particular oxygen content in the regeneration gas may also be required. For this purpose, it may be the case that oxygen and/or air are/is fed into the gas circuit. The amount fed in can especially be adjusted using a closed-loop control unit which works on the basis of a measured amount of oxygen in the gas circuit. It the amount of oxygen required for regeneration exceeds a given value, an additional connection for instrument air may be provided for safety reasons.

As likewise elucidated in part, the purifying unit may comprise a plurality of purifying vessels each filled with a purifying medium and the regenerating unit may be set up for alternative, successive or simultaneous guiding of the regeneration gas stream through at least two purifying vessels. As elucidated, especially in the case of a non-constant requirement for regeneration and/or in the case of a low time demand for a corresponding regeneration, it is advantageous when the purifying unit is set up, in terms of capacity, only for simultaneous regeneration of a purifying vessel. This has a smaller construction and can therefore be produced much less expensively.

More particularly, the regenerating unit is also set up to conduct, the regeneration gas stream temporarily not through the purifying unit. During such periods, the purifying unit can be bypassed, for example, with a bypass conduit. These periods are those in which the purifying unit is working catalytically and/or adsorptively and is not being regenerated. A regenerating unit configured in accordance with the invention can also be shut down during such periods.

As elucidated, the present invention is especially suitable for use in polymerization plants set up for obtaining at least one ethylene-propylene elastomer from ethylene and propylene.

In this case, the purifying unit is advantageously set up for at least partial removal of hydrogen, oxygen, water, carbon monoxide, carbon dioxide, ammonia, methanol, acetylene, methylacetylene, carbon disulfide, carbonyl sulfide, sulfur, hydrogen arsenide, hydrogen sulfide, mercaptans, nitriles, oxygenates and/or phosphines from the at least one gaseous, hydrocarbon-rich feed stream. The regenerating unit, as elucidated, can be adapted in a particularly flexible manner to the components to be removed in each case and/or the purifying media used for the purpose.

The purifying unit here may advantageously have at least one modified alumina and/or at least one metal oxide catalyst. It is also possible for further absorptive and/or catalytic purifying media to be provided and regenerated in a manner known in each case.

With regard to the features and advantages of the regenerating unit of the invention, reference is made explicitly to the above elucidations. According to the invention, it is a feature of such a regenerating unit, especially for a polymerisation plant for obtaining at least one polymerization product as elucidated above, that it is set up for at least temporary conditioning and guiding of a regeneration gas stream through a catalytic and/or adsorptive purifying unit by means of a partly closed gas circuit, as elucidated above.

The invention likewise provides a method of regenerating a catalytic and/or adsorptive purifying unit of a polymerization plant for obtaining at least one polymerization product from at least one gaseous, hydrocarbon-rich feed stream. In this case, the purifying unit is set up for at least partial removal of at least one unwanted component in the at least one feed stream. The method of the invention comprises using a regenerating unit by means of which a regeneration gas stream is at least temporarily conditioned and conducted through the purifying unit by means of a partly closed gas circuit of the regenerating unit. The features of the method of the invention have already been elucidated above with reference to the polymerization plant envisaged in accordance with the invention. More particularly, conduction of the method of the invention in a polymerization plant already elucidated above is envisaged.

This advantageously comprises at least two different modes of operation in which the regeneration gas stream can be conditioned in different ways and hence adapted to the particular regeneration tasks.

The invention is elucidated in detail hereinafter with reference to the appended drawings, which show preferred embodiments of the invention.

### BRIEF DESCRIPTION OF THE DRAWINGS

FIG. 1 shows a polymerization plant in one embodiment of the invention in schematic view.

### DETAILED DESCRIPTION OF THE DRAWINGS

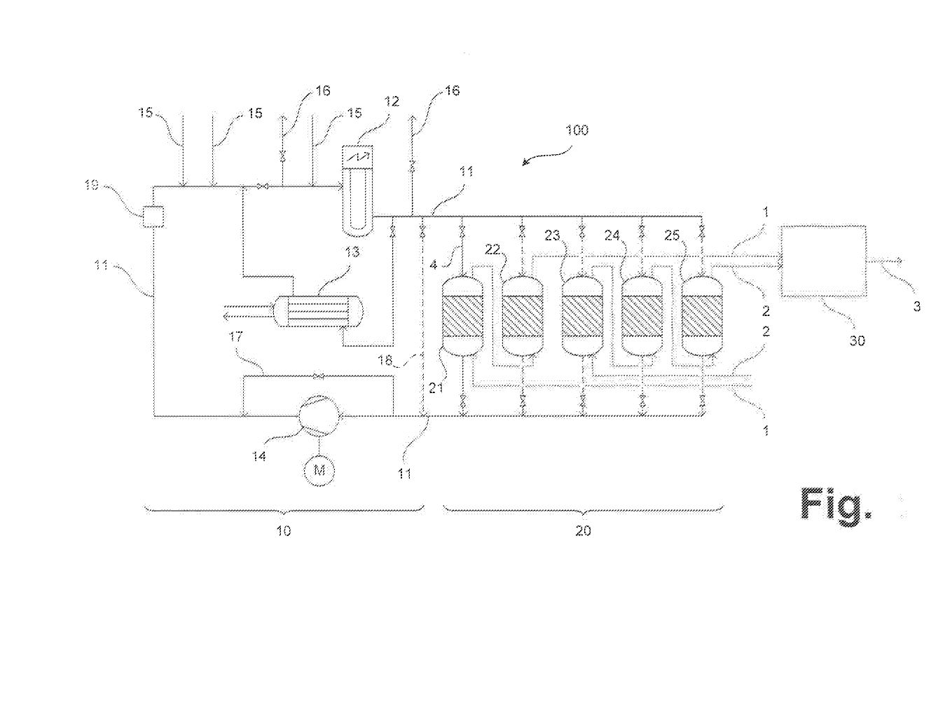

FIG. 1 shows a schematic of a polymerization plant in one embodiment of the invention, labeled 100 as a whole. The polymerization plant 100 is shown in highly schematic form. More particularly, the representation of a multitude of valves and of open-loop and closed-loop control devices has been dispensed with.

The polymerization plant 100 in the example shown is supplied with two hydrocarbon-rich feed streams 1 and 2, which may, for example, be ethylene and/or propylene.

The polymerisation plant 100 comprises a purifying unit 20 and a regenerating unit 30, and also a polymerization unit 30 shown merely in schematic form. A polymerization product 3 is obtained therein. In the normal operation of a corresponding polymerization, plant 100, the hydrocarbon-rich feed streams 1, 2 are conducted through purifying vessels 21 to 25 of the purifying unit 20 and polymerized in the polymerization unit 30.

In the normal operation of a corresponding polymerization plant 100, for example, the feed stream 1 is conducted first through the purifying vessel 21 and then through the purifying vessel 22. The teed stream 2, in contrast, is conducted first through the purifying vessel 23, then through the purifying vessel 24 and finally through the purifying vessel 25.

FIG. 1, however, shows regenerative operation for the purifying unit 20. This means that the hydrocarbon-rich feed streams 1, 2 at the juncture shown are not being conducted through the purifying unit 20, as illustrated here by dotted arrows. The purifying unit 20 is being regenerated, with a regeneration gas stream 4 in the example shown being conducted through the purifying unit 21. The other purifying vessels 22 to 25 are not currently being regenerated, as illustrated here with dotted arrows. The regenerating unit 10 in the example shown is configured for successive regeneration of the purifying vessels 21 to 25, such that a regeneration gas stream 4 is conducted successively through the purifying vessels 21 to 25. As elucidated, however, it is also possible for two or more of the purifying vessels 21 to 25 to be purified in parallel.

The regenerating unit 10 comprises a partly closed gas circuit 11. As elucidated, a corresponding gas circuit 11 is partly closed when, in each pass, only at most 25% of the gas present, the regeneration gas stream 4 here, is exchanged. A regeneration gas stream 4 in the gas circuit 11 can be conditioned in different ways in the regenerating unit 10, for example beamed by means of a heating unit 12, cooled down by means of a cooling unit 13 which can be operated with a cooling water circuit illustrated only by suggestion, and compressed by means of a compressor 14 coupled to a motor M. By means of feed units 15, if is possible to feed in gas streams, which may, for example, be nitrogen, air and/or further gas components.

In addition, in the example shown, two withdrawal units 16 are provided, which are provided with corresponding valves. At the withdrawal units 16, a portion of the regeneration gas stream 4 conducted within the gas circuit 11 can be discharged. By means of an appropriate setting of the valves in the withdrawal units 16, a suitable backpressure can be set in the gas circuit 11, such that the regeneration gas stream 4 is always available with a given pressure. The regenerating unit or the gas circuit 11 thereof may comprise several bypass lines, illustrated here using the example of bypass lines 17 and 18. For example, it is possible thereby to bypass the compressor 14 and/or the purifying unit 20 (when no regeneration gas stream 4 is required in the purifying unit 10.

At different points in the gas circuit 11, it is possible to provide means of measurement and/or closed-loop control 19, which are illustrated here in highly schematized form. For example, it is possible by means of appropriate means of measurement to measure an oxygen content of the regeneration gas stream 4 in the gas circuit 11 and/or a pressure, and on this basis to set a feed of air and/or oxygen and/or a valve position in the withdrawal units 16.

1. A polymerization plant for obtaining at least one polymerization product from at least one gaseous, hydrocarbon-rich feed stream, having at least one catalytic and/or adsorptive purifying unit for at least partial removal of at least one unwanted component in the at least one feed stream, and having a regenerating unit for regeneration of the purifying unit, characterized in that the regenerating unit is set up for at least temporary conditioning and guiding of a regeneration gas stream through the purifying unit by means of a partly closed gas circuit.

2. The polymerization plant as claimed in claim 1, wherein at least one heating unit, at least one cooling unit and/or at least one compressor are arranged in the gas circuit.

3. The polymerization plant as claimed in claim 1, wherein the gas circuit has at least one feed unit and/or at least one withdrawal unit for a gas stream.

4. The polymerization plant as claimed in claim 1, wherein the purifying unit comprises a plurality of purifying vessels each filled with a purifying medium and the regenerating unit is set up for alternative or simultaneous guiding of the regeneration gas stream through at least two purifying vessels.

5. The polymerization plant as claimed in claim 1, wherein the regenerating unit is set up for operation in different operating phases in which the regeneration gas stream is conditioned in different ways by means of the regenerating unit.

6. The polymerization plant as claimed in claim 1, wherein the regenerating unit is set up to guide the regeneration gas stream temporarily not through the purifying unit.

7. The polymerization plant as claimed in claim 1, which is set up to obtain at least one ethylene-propylene elastomer formed from ethylene and propylene.

8. The polymerization plant as claimed in claim 1, wherein the purifying unit is set up for at least partial removal of hydrogen, oxygen, water, carbon monoxide, carbon dioxide, ammonia, methanol, acetylene, methylacetylene, carbon disulfide, carbonyl sulfide, sulfur, hydrogen arsenide, hydrogen sulfide, mercaptans, nitriles, oxygenates and/or phosphines from the at least one gaseous, hydrocarbon-rich feed stream.

9. The polymerization plant as claimed in claim 1, wherein the purifying unit has at least one modified alumina and/or at least one metal oxide catalyst.

10. A The regenerating unit as claimed in claim 1 characterized by means for at least temporarily conditioning and guiding a regeneration gas stream through a catalytic and/or adsorptive purifying unit in the form of a partly closed gas circuit.

11. A method of regenerating a catalytic and/or adsorptive purifying unit of a polymerization plant for obtaining at least one polymerization product from at least one gaseous, hydrocarbon-rich feed stream, set up for at least partial removal of at least one unwanted component in the at least one feed stream, characterized in that a regenerating unit by means of which a regeneration gas stream is at least temporarily conditioned and conducted through the purifying unit in the form of a partly closed gas circuit is used.

12. The method as claimed in claim 11, which is conducted in a polymerization plant for obtaining at least one polymerization product from at least one gaseous, hydrocarbon-rich feed stream having at least one catalytic and/or adsorptive purifying unit for at least partial removal of at least one unwanted component in the at least one feed stream, and having a regenerating unit for regeneration of the purifying unit, characterized in that the regenerating unit is set up for at least temporary conditioning and guiding of a regeneration gas stream through the purifying unit by means of a partly closed gas circuit.

13. The method as claimed in claim 11, which is conducted in at least two different operating modes in which the regeneration gas stream is conditioned in different ways.
